(19) United States
(12) Patent Application Publication
(10) Pub. No.: US 2016/0269517 A1
(43) Pub. Date: Sep. 15, 2016

(54) WATERPROOF PROTECTIVE CASE FOR ELECTRONIC DEVICES

(71) Applicant: Spark Innovation LLC, Orem, UT (US)

(72) Inventor: Matthew Alexander, Powell, WY (US)

(73) Assignee: Spark Innovation LLC, Orem, UT (US)

(21) Appl. No.: 15/069,747

(22) Filed: Mar. 14, 2016

Related U.S. Application Data
(60) Provisional application No. 62/132,773, filed on Mar. 13, 2015.

(51) Int. Cl. H04M 1/18; H04B 1/3888

(52) U.S. Cl. CPC H04M 1/18; H04B 1/3888; H04B 2001/3894

(57) ABSTRACT

A waterproof protective case. The waterproof protective case includes a body, wherein the body includes a cavity configured to receive an electronic device. The waterproof protective case also includes a door, wherein the door is configured to more relative to the body from a closed position to an open position. The waterproof protective case further includes a seal, wherein the seal is configured to ensure that the mating between the door and the body is waterproof when the door is in a closed position.

### CROSS-REFERENCE TO RELATED APPLICATIONS

This application claims the benefit of and priority to U.S. Provisional Patent Application Ser. No. 62/132,773 filed on Mar. 13, 2016, which application is incorporated herein by reference in its entirety.

### BACKGROUND OF THE INVENTION

Users are becoming increasingly attached to their electronic devices. As a result, these devices are becoming more and more likely to be damaged. Water damage, in particular, can be devastating to many electronic devices. There are products that seek to protect these devices from water damage. However, these products often render the device unusable. That is, the user either cannot use the electronic device when within the waterproof product or doing so is very unwieldy.

Accordingly, there is a need in the art for a waterproof protective case that allows a user full access to an electronic device.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a waterproof protective case. The waterproof protective case includes a body, wherein the body includes a cavity configured to receive an electronic device. The waterproof protective case also includes a door, wherein the door is configured to more relative to the body from a closed position to an open position. The waterproof protective case further includes a seal, wherein the seal is configured to ensure that the mating between the door and the body is waterproof when the door is in a closed position.

Another example embodiment includes a waterproof protective case. The waterproof protective case includes a body, wherein the body includes a cavity configured to receive an electronic device. The waterproof protective case also includes a door, wherein the door is configured to more relative to the body from a closed position to an open position. The waterproof protective case further includes a window. The window forming at least a portion of the door and configured to allow a user to access the electronic device. The waterproof protective case additionally includes a compressive material within the body. The compressive material is configured to receive the electronic device and press the electronic device against the window. The waterproof protective case moreover includes a seal, wherein the seal is configured to ensure that the mating between the door and the body is waterproof when the door is in a closed position.

Another example embodiment includes a waterproof protective case. The waterproof protective case includes a body, wherein the body includes a cavity configured to receive an electronic device. The waterproof protective case also includes a door, wherein the door is configured to more relative to the body from a closed position to an open position. The waterproof protective case further includes a window. The window forming at least a portion of the door and configured to allow a user to access the electronic device. The waterproof protective case additionally includes a compressive material within the body. The compressive material is configured to receive the electronic device and press the electronic device against the window. The waterproof protective case moreover includes a seal, wherein the seal is configured to ensure that the mating between the door and the body is waterproof when the door is in a closed position. The waterproof protective case also includes a hinge, wherein the hinge is configured to allow the door to move from the closed position to the open position. The waterproof protective case further includes and a latch, wherein the latch is configured to prevent the door from moving from the closed position.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a side view of the example of a waterproof protective case;

FIG. 1B is an exploded side cut away view of the example of a waterproof protective case;

FIG. 2 illustrates a cut away view of a waterproof protective case with an electronic device; and

FIG. 3 illustrates an example of the waterproof protective case in water.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

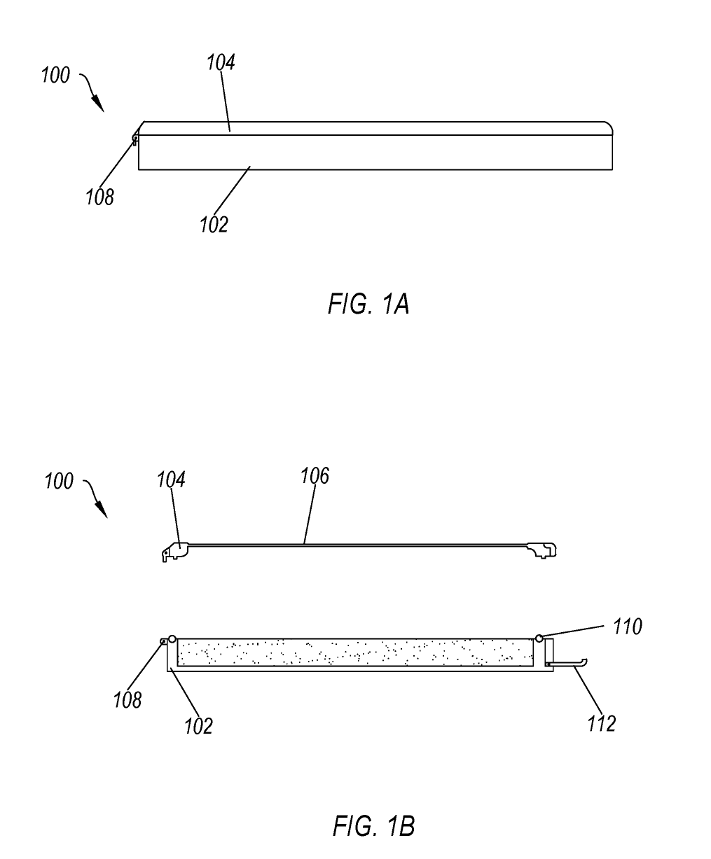

FIGS. 1A and 1B (collectively “FIG. 1”) illustrate an example of a waterproof protective case 100. FIG. 1A is a side view of the example of a waterproof protective case 100; and FIG. 1B is an exploded side cut away view of the example of a waterproof protective case 100. The waterproof protective case 100 can be used for smartphones, tablets, or any other desired electronic device. In particular, the waterproof protective case 100 both protects the electronic device and allows a user to continue to use the electronic device (e.g., a keyboard or touch screen.).

FIG. 1 shows that the waterproof protective case 100 can include a body 102. The body 102 is made of a waterproof material, such as plastic. The body 102 forms a cavity for receiving the electronic device. That is, the body 102 includes at least one cavity that has sufficient space to receive the electronic device. As used herein, “waterproof” shall mean that the material is impervious to water in any state (e.g., liquid, gaseous, solid, etc.).

FIG. 1 also shows that the waterproof protective case 100 can include a door 104. The door 104 is waterproof to prevent moisture from reaching the electronic device. I.e., the door 104 in combination with the body 102 forms a complete shell around the electronic device. The door 104 can move relative to the body 102, as described below.

FIG. 1 additionally shows that the waterproof protective case 100 can include a window 106 within the door. The window 106 can form a portion of the door or the entirety of the door, as desired. The window 106 allows the user to access the electronic device within the body 102. That is, the window 106 forms a cover through which the user can use the electronic device. For example, the window 106 can include a material, such as a flexible plastic or polymer, that allows a user to use a touchscreen or keyboard through the door 104.

FIG. 1 further shows that the waterproof protective case 100 can include a hinge 108. The hinge 108 allows the door 104 to move relative to the body 102. In particular, since the door 104 can move relative to the body 102 the waterproof protective case 100 can be opened to allow direct access to the electronic device or allow the electronic device to be placed in or removed from the waterproof protective case 100. The hinge 108 can be placed along the edge that will be the bottom of the case when mounted to ensure that if when the door 104 is opened that the electronic device does not fall out of the body 102.

FIG. 1 additionally shows that the waterproof protective case 100 can include a seal 110. The seal 110 ensures that the mating between the door 104 and the body 102 is waterproof. That is, when the door 104 is positioned such that the seal 110 is between the door 104 and the body 102 (i.e., closed), the entire mechanism is waterproof. I.e., water is unable to pass through the body 102, the door 104 or the seal 110, thus the whole waterproof protective case 100 is waterproof when the door 104 is closed.

FIG. 1 moreover shows that the waterproof protective case 100 can include a latch 112. The latch 100 holds the door 104 relative to the body 102. That is, the latch 112 prevents movement of the door 104 relative to the body 102. I.e., the latch 112 holds the door 102 in the closed position when the latch 112 is engaged.

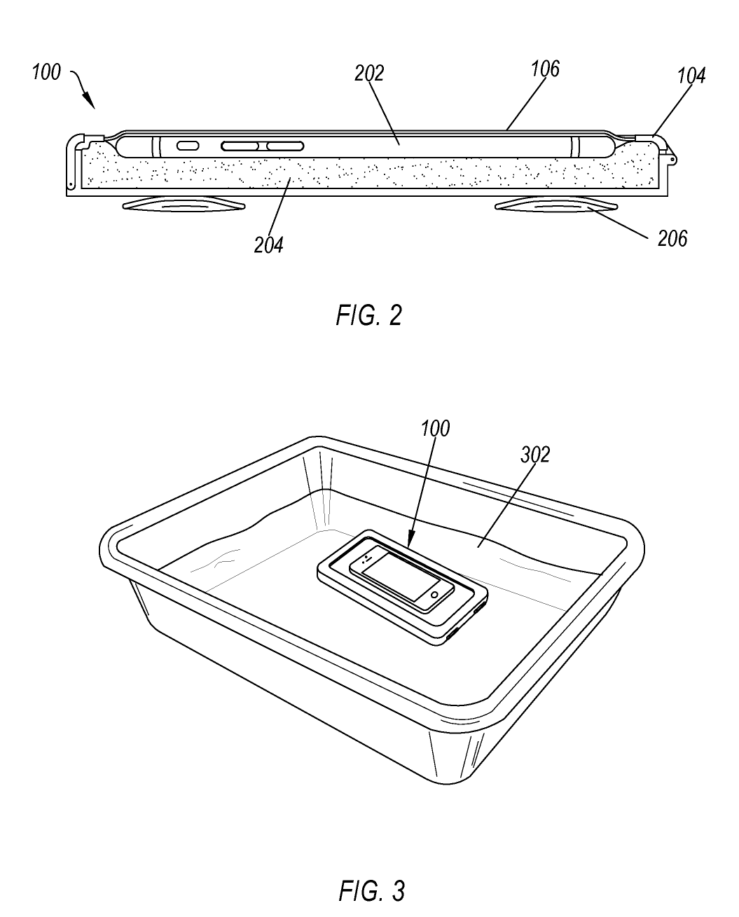

FIG. 2 illustrates a cut away view of a waterproof protective case 100 with an electronic device 202. The cutaway view shows that the waterproof protective case 100 can retain the electronic device 202 while protecting the electronic device form water and while allowing the user to use the electronic device.

FIG. 2 shows that the waterproof protective case 100 can include a compressive material 204. The compressive material 204 can include any material that will seek to expand when compressed. For example, the compressive material 204 can include foam, elastic gel, rubber, etc. The compressive material 204 is configured to press the electronic device against the window 106. That is, when the electronic device is present the compressive material 204 keeps the electronic device against the window 106, allowing the user to use the device (touchscreen, keyboard, etc.) through the door 104. Likewise, the compressive material 204 can allow the waterproof protective case 100 to accommodate different electronic devices 202. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. As a result, the phrase “configured to” reaches well beyond merely describing functional language or intended use since the phrase actively recites an actual state of configuration.

FIG. 2 shows that the waterproof protective case 100 can include a mounting mechanism 206. The mounting mechanism 204 is configured to allow the waterproof protective case 100 to be mounted on a surface. For example, the mounting mechanism 206 can include a suction cup, hooks, tabs, holes or any other desired mechanism.

FIG. 3 illustrates an example of the waterproof protective case 100 in water 302. The waterproof protective case 100 can be configured such that the whole, including the electronic device, is less dense than water. This will ensure that the waterproof protective case 100 floats, allowing the case to be easily retrieved if it falls into a body of water 302. For example, the compressive material 204 can be of sufficient size to lower the density to be less than the density of water. Likewise, the material for the body 102 and door 104 can be of low enough density to allow the waterproof protective case 100 to float.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A waterproof protective case, the waterproof protective case including:
a body, wherein the body includes a cavity configured to receive an electronic device;
a door, wherein the door is configured to more relative to the body from a closed position to an open position; and
a seal, wherein the seal is configured to ensure that the mating between the door and the body is waterproof when the door is in a closed position.

2. The waterproof protective case of claim 1 further comprising a window, the window:
forming at least a portion of the door.

3. The waterproof protective case of claim 2, wherein the window is configured to allow a user to access the electronic device

4. The waterproof protective case of claim 1 further comprising a compressive material within the body.

5. The waterproof protective case of claim 4, wherein the compressive material is configured to receive the electronic device.

6. The waterproof protective case of claim 4, wherein the compressive material is configured to press the electronic device against the window.

7. The waterproof protective case of claim 1 further comprising a hinge, wherein the hinge is configured to allow the door to move from a closed position to an open position.

8. The waterproof protective case of claim 1 further comprising a latch, wherein the latch is configured to prevent the door from moving from a closed position.

9. A waterproof protective case, the waterproof protective case including:
a body, wherein the body includes a cavity configured to receive an electronic device;
a door, wherein the door is configured to more relative to the body from a closed position to an open position;
a window, the window:
forming at least a portion of the door; and
configured to allow a user to access the electronic device;
a compressive material within the body, the compressive material configured to:
receive the electronic device; and
press the electronic device against the window;
a seal, wherein the seal is configured to ensure that the mating between the door and the body is waterproof when the door is in a closed position.

10. The waterproof protective case of claim 9, wherein the compressive material is elastic.

11. The waterproof protective case of claim 9, wherein the compressive material includes a foam.

12. The waterproof protective case of claim 9, wherein the window is touch screen sensitive.

13. A waterproof protective case, the waterproof protective case including:
a body, wherein the body includes a cavity configured to receive an electronic device;
a door, wherein the door is configured to more relative to the body from a closed position to an open position;
a window, the window:
forming at least a portion of the door; and
configured to allow a user to access the electronic device;
a compressive material within the body, the compressive material configured to:
receive the electronic device; and
press the electronic device against the window;
a seal, wherein the seal is configured to ensure that the mating between the door and the body is waterproof when the door is in a closed position;
a hinge, wherein the hinge is configured to allow the door to move from the closed position to the open position; and
a latch, wherein the latch is configured to prevent the door from moving from the closed position.

14. The waterproof protective case of claim 13 further comprising a mounting mechanism attached to the body.

15. The waterproof protective case of claim 14, wherein the mounting mechanism includes a suction cup.

16. The waterproof protective case of claim 14, wherein the mounting mechanism includes a hook.

17. The waterproof protective case of claim 14, wherein the mounting mechanism includes a tab.

18. The waterproof protective case of claim 13, wherein the density of the waterproof protective case is less than the density of water.
